(19) United States
(12) Patent Application Publication
(10) Pub. No.: US 2017/0225599 A1
(43) Pub. Date: Aug. 10, 2017

(54) Game Carriers

(71) Applicant: Jerome Francis Russo, Santa Fe, TX (US)

(72) Inventor: Jerome Francis Russo, Santa Fe, TX (US)

(21) Appl. No.: 15/040,062

(22) Filed: Feb. 10, 2016

(51) Int. Cl. B60P 1/28; B66C 23/44; B60P 1/14; B60D 1/06; B60P 3/04; B60R 9/06; A01M 31/00

(52) U.S. Cl. CPC B60P 1/283; B60R 9/06; B66C 23/44; A01M 31/00; B60D 1/06; B60P 3/04; B60P 1/14

(57) ABSTRACT

The user removes the pin, located by the pivot bolt, unwinds the cable from the spindle of the winch, lowering the game carrier to the ground. The user pulls the strap or cable up to 25′ to the game and places the strap or cable around the game. The user then cranks the winch by rotating the handle or pushes the button on the electric winch, and guides the game up and onto the game carrier. Rotating the handle it takes up the strap or cable. The user can unhook the strap or cable from around the game, and attach the hook to the d-ring located on the front of the game carrier and rotate the handle or push the button to pull the game carrier back to the original position and relocate the pin in the hole located by the pivot bolt. Your game is ready for transport.

### BACKGROUND OF THE INVENTION

1. Reason for the Invention

The present invention relates to an ATV mounted game carriers and/or any 2″ style hitch receiver and pertains to a new invention to assist in pulling, dragging, lifting, loading and transporting your game to a hitch-mounted tilting/pivoting game carrier.

2. Description of the Prior Art

The use of vehicle-mounted game carriers is known in the prior art. More specifically, vehicle-mounted game carrier devices were utilized and known similar structural, configurations, notwithstanding the myriad of designs encompassed by the crowded prior art which have been developed for the fulfillment of countless objectives and requirements.

Known prior art includes U.S. Pat. No. 6,152,75; U.S. Pat. No. 6,089,431; U.S. Pat. No. 6,095,349; U.S. Pat. No. 6,250,483; U.S. Pat. No. 5,791,858; and U.S. Pat. No. Des. 429,051.

While these devices fulfill their respective, particular objectives and requirements, the aforementioned patents do not disclose a new hitch-mounted tilting/pivoting game carrier device. The prior art includes frames mounted to hitches of vehicles and also includes winches and cables used to suspend the game off the ground and from the vehicles.

### SUMMARY OF THE INVENTION

The general purpose of the game carrier, is to provide a new hitch-mounted device which has many of the advantages, for the use of a receiver mounted device used for ATVs and/or other 2″ receiver hitch type vehicles. We will mention many novel features that result in a new hitch-mounted tilting/pivoting game carrier device which is not anticipated, rendered obvious, suggested, or even implied by any of the prior art receiver hitch mounted game carriers, either alone or in any combination thereof. The present invention includes a support basket with a receiver mount being adapted to be fastened to a receiver hitch of an ATV and/or any 2″ mounted receiver hitch; and also includes a winch assembly being mounted to the 2″ square tubular up right bar at 73 degrees angle and including a winch and a cable being carried by the winch; and further includes a tilting/pivoting game carrier device being supported by the solid basket device for carrying the game. None of the prior art includes the combination of the elements of the present invention.

There has thus been outlined, rather broadly, the more important features of the hitch-mounted game carrier device in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

It is an object of the present invention to provide a new hitch-mounted game carrier device which has many of the advantages of the vehicle-mounted game carriers mentioned heretofore and many novel features that result in a new hitch-mounted game carrier device which is not anticipated, rendered obvious, suggested, or even implied by any of the prior art vehicle-mounted game carriers, either alone or in any combination thereof.

Still another object of the present invention is to provide a new hitch-mounted game carrier device for hauling in using a cable mounted winch or nylon strap for loading purposes and transporting game.

Still yet another object of the present invention is to provide a new hitch-mounted game carrier device that is extremely easy to setup and very convenient to use no matter the person or persons situation. (examples: age, disability, strength, gender, etc. . . . )

Main objective of the present invention is to provide a new hitch-mounted game carrier device that allows a user to easily load one's game for the transporting.

The information and listed objects of the invention, along with the all of its features of novelty characterize the invention, are pointed out in the claims annexed to and the forming a part of its disclosure. The best understanding for the invention is its operating advantages and the specific characteristics attained by its uses, references should be made to the accompanying drawings and descriptive matter illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a top view of a basket assembly of the present invention of a new hitch-mounted game carrier device according to the present invention.

FIG. 2 is a front perspective view of the present invention.

FIG. 3 is a right side detailed view of the present invention.

FIG. 4 is a right side view of the pivoting/tilting basket of the present invention.

### DESCRIPTION OF THE PREFERRED EMBODIMENT

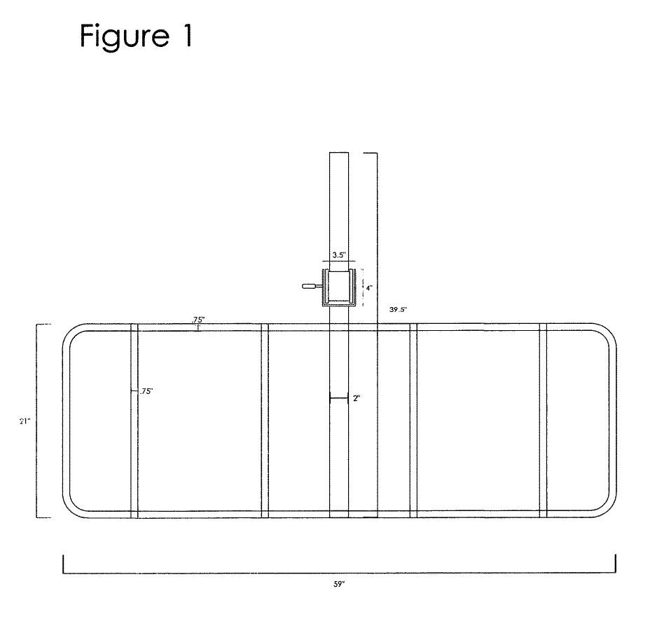

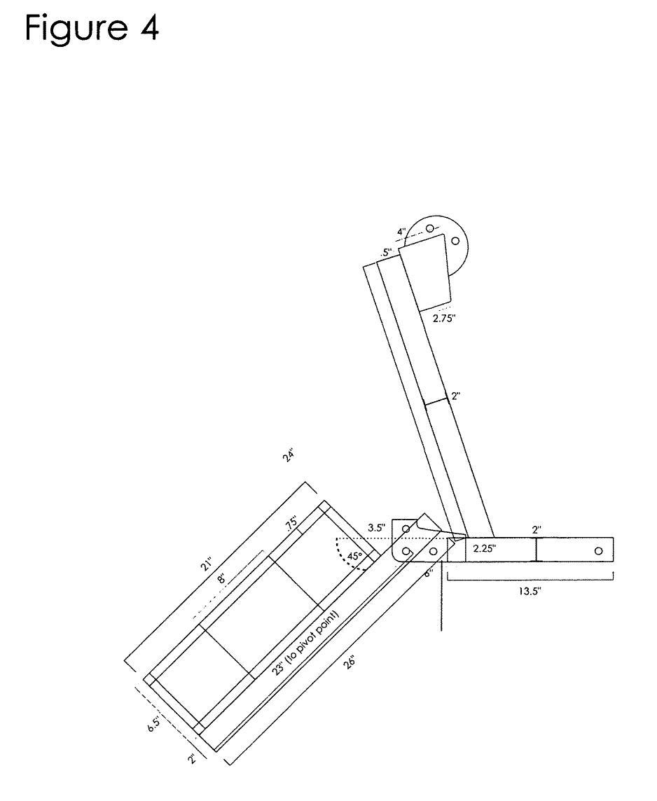

With reference now to the drawings, and in particular to FIG. 1 through 4 thereof, a new hitch-mounted game carrier device embodying the principles and concepts of the present invention.

As best illustrated in FIG. 1 through 4, the hitch-mounted game carrier device generally comprises a support assembly being adapted to be fastened to a hitch of an ATV and/or any 2″ receiver.

Top view FIG. 1 is of tubular support and rectangular fashion 59″ L×21″ W to support a load max weight up to 500 lbs.

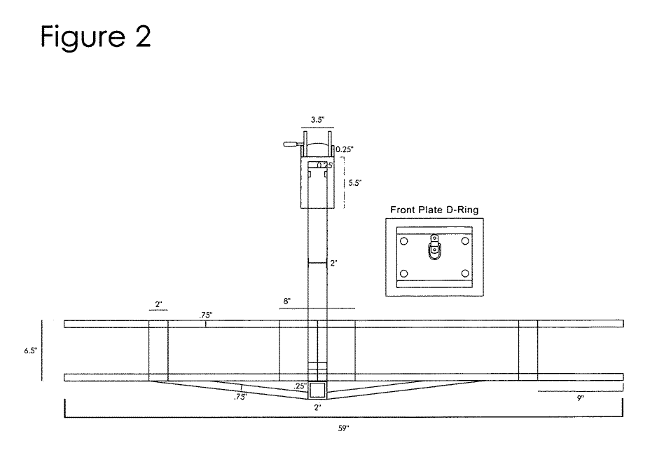

Front view FIG. 2 is of tubular side walls of 6½″H and a tubular bar of 24″ tall facing forward at a 70 degree angle with a crank or electric winch mounted.

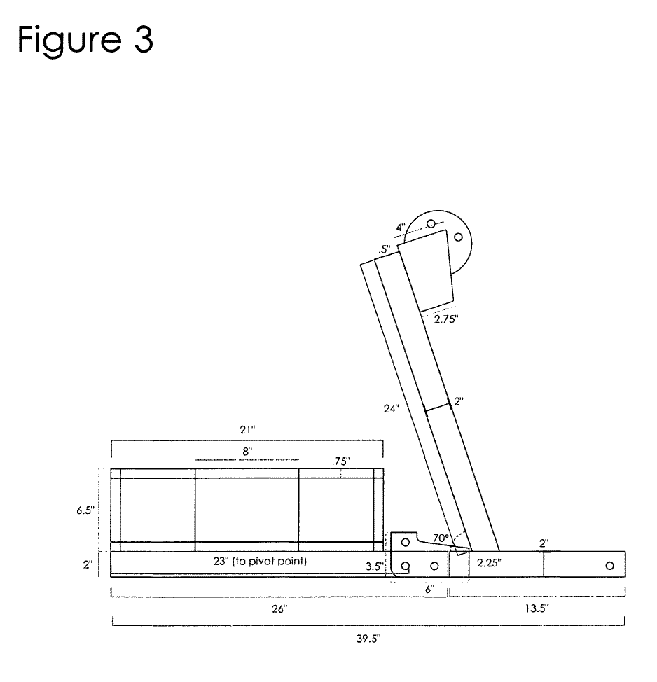

Right side view FIG. 3 is of tubular support 21″W of the carrier, side walls of 6½″H, 23″W to the pivot/tilting point and a pin hole with a pin ⅝″ in diameter that prevents the carrier from pivoting, 26″W of tubular support and 39½″W to end of the tubular bar (hitch receiver with pin hole). 2″ tubular bar 24″H at a 70 degree angle and 24′/2″H to base mounted winch.

A winch assembly is securely mounted to the support assembly and includes a winch with a 25′ nylon strap or a 25′ steel cable. The winch assembly further includes a handle, detachably attached with a fastening nut to a spindle of the winch or a push button electrified by a 12 Volt battery for taking up the strap or cable.

The game carrier device is supported by the support assembly for loading and transporting the game. The game carrier assembly includes a hook being securely attached to an end of the strap or cable, and also includes a d-ring on the front of the carrier to secure with the hook attached to the strap or cable to the d-ring.

In use, the user removes the pin, located by the pivot bolt, unwinds the cable from the spindle of the winch, lowering the game carrier to the ground, and the user pulls the strap or cable up to 25′ to the game and places the strap or cable around the game. The user then cranks the winch by rotating the handle or pushes the button on the electric winch, and guides the game up and onto the game carrier. By rotating the handle it takes up the strap or cable. Once finished, the user can unhook the strap or cable from around the game, and attach the hook to the d-ring located on the front of the game carrier and rotate the handle or push the button to pull the game carrier back to the original position and relocate the pin in the hole located by the pivot bolt. Your game is now loaded and ready for transport.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the hitch-mounted game carrier device. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A hitch-mounted tilting/pivoting game carrier device made up of: a 2″ receiver hitch, made for ATV and/or any 2″ style receiver hitch, square tubular assembly attaching to a tilting/pivoting rectangular rack and/or basket, 59″ L×6½″ H×21″ W, held in place by a pin with a clip, and a d-ring anchor attached to the front of the basket. It contains a second square tubular member upward angled at 70 degrees, with a mounted winch electric or hand crank style. The winch includes a wire cable and/or a 25′ flat nylon strap, for hauling in your game, with a hook & spring loaded mechanism. The game carrier device being supported is rated for carrying any game up to 500 lbs.

2. In addition to the hitch-mounted tilting/pivoting game carrier device as described in claim 1, the winch assembly includes a handle or button, hand crank winch or electric winch that allows for taking up cable or nylon strap.

3. In addition to the hitch-mounted tilting/pivoting game carrier device as described in claim 2, the game carrier device with a winch includes a hook being attached to the end of the cable or strap. The hook has a spring-loaded mechanism to allow clamping the hook securely.

4. The hitch-mounted tilting/pivoting game carrier device as described in claim 3, allows for the spring loaded hook to be attached when wrapping the wire cable or strap around the game, or to a strap harness to drag the game to the game carrier. After the game is loaded into the game carrier, the hook with strap is released manually using the spring loaded mechanism (part of the hook), reattached to the front of the game carrier's metal d-ring anchor and lifts the game carrier back to its original non-pivoting state.

5. In addition to the hitch-mounted tilting/pivoting game carrier device as described in claim 4, the game carrier has a mounted metal d-ring anchor attached to the front of the game carrier which lifts the game carrier basket loaded or not loaded and holds the game to the loaded game carrier, for transporting.

6. In addition to the hitch-mounted tilting/pivoting game carrier device as described in claim 5, the game carrier device includes a basket having a mesh support floor/bottom 59″L×21″ W and also having side walls 6½ ″H. The game carrier basket is of solid construction made specifically to carry up to 500 lbs.
